(19) United States
(12) Patent Application Publication
(10) Pub. No.: US 2009/0119281 A1
(43) Pub. Date: May 7, 2009

(54) Granular knowledge based search engine

(76) Inventors: Andrew Chien-Chung Wang, Chino, CA (US); Tsau Young Lin, Chino, CA (US); I-Jen Chiang, Chino, CA (US)

Correspondence Address: LAW OFFICES OF CLEMENT CHENG, 17220 NEWHOPE STREET #127, FOUNTAIN VALLEY, CA, 92708, US

(21) Appl. No.: 11/998,222

(22) Filed: Nov. 29, 2007

Related U.S. Application Data
(63) Continuation of application No. 61/001,526, filed on Nov. 3, 2007.

(51) Int. Cl. G06F 7/10; G06F 17/30

(52) U.S. Cl. 707/5; 707/E17.017

(57) ABSTRACT

The application borrows terminology from data mining, association rule learning and topology. A geometric structure represents a collection of concepts in a document set. The geometric structure has a high-frequency keyword set that co-occurs closely which represents a concept in a document set. Document analysis seeks to automate the understanding of knowledge representing the author's idea. Granular computing theory deals with rough sets and fuzzy sets. One of the key insights of rough set research is that selection of different sets of features or variables will yield different concept granulations. Here, as in elementary rough set theory, by “concept” we mean a set of entities that are indistinguishable or indiscernible to the observer (i.e., a simple concept), or a set of entities that is composed from such simple concepts (i.e., a complex concept).

This application claims priority from U.S. Provisional Application 61/001,526 filed Nov. 3, 2007 having the same title by the same inventors.

### DISCUSSION OF RELATED ART

A search engine is an information retrieval system designed to help find information stored on a computer system. Search engines help to minimize the time required to find information and the amount of information which must be consulted, akin to other techniques for managing information overload. The most public, visible form of a search engine is a Web search engine which searches for information on the World Wide Web.

Popular search engines such as Google provide the public with powerful information tools. Beginning users are typically unfamiliar with advanced terminology, syntax and advanced operators. A large volume of work has been created to teach users how to maximize search results in the popular search engines such as Google. These websites specific techniques are taught in a variety of books. Nonetheless, users must spend time to learn these advanced techniques.

Search engines provide an interface to a group of items that enables users to specify a search query and have the engine find the matching items. In the case of text search engines, the search query is typically expressed as a set of words also known as a keyword set that identifies the desired concept or idea or a bit of knowledge that one or more documents known as a document set may contain.

Approaches to document clustering can be classified into two major categories, namely supervised and unsupervised approaches. Both approaches work differently and have certain drawbacks. The supervised approach maps data into pre-defined models or classes. It is called supervised because the clusters are pre-determined. The approach uses training data that maps certain type of documents to a certain type of cluster. Training data is used to make the system able to decide to which cluster a document should be assigned. Some techniques which can be categorized as supervised approaches are Artificial Neural Networks, Naive Bayes Classifier, Regression, Time Series Analysis, and Support Vector Machine (SVM). Although it is popular, the supervised techniques have major drawbacks. One of them is that the pre-defined classes must be made sufficiently to accommodate the data. If the choice of classes is too large, the complexity of the learning process would be extremely high. This makes the supervised techniques not scale well when it comes to processing very large documents.

The unsupervised approaches do not use pre-defined models or classes to cluster data. The clusters are defined naturally based on the characteristics of the data. The most popular unsupervised techniques for text categorization are the Space Vector Model and the Latent Semantic Index (LSI). These techniques map documents and terms into vectors within multi-dimensional space and use cosine function to measure document similarity. One major limitation of these techniques is not capturing the semantic of documents. These techniques treat a document as a bag of keywords, and the same keywords might have a different meaning.

The LSI is one of the most popular unsupervised techniques for document retrieval. It creates term-document matrix and uses the Singular Value Decomposition (SVD) technique to create latent semantic structures. The main reason why it is believed that the LSI does not capture the “concept” of documents is that the LSI treats documents as a bag of words and does not take into account the keyword's position and association. It uses information of words occurrence in documents but ignores their association.

Another limitation of the LSI technique is that it does not handle polysemy well. Polysemy is the problem where one word can have more than one different meaning. Synonymy is the problem where one meaning can be expressed using more than one word. LSI handles synonymy well, but not polysemy. The problem of polysemy occurs quite often. Virtually every sentence contains polysemy. Most words are polysemous to some degree, and the more frequent a word is, the more polysemous it tends to be.

In the prior art, there is a wide variety of methods for producing different web page search results, and for ranking the Web page search results. Some page ranking algorithms are discussed in Broder U.S. Pat. No. 6,560,600 issued May 6, 2003, the disclosure of which is incorporated herein by reference. The method and apparatus for ranking page search results typically uses a neighborhood graph and adjacency matrix for determining which pages are linked to which pages. The focus on links provides a certain type of search result.

It is also commonly and widely known that “Google” employs a page rank algorithm using a citation-based technique. As discussed in U.S. Pat. No. 7,080,073 issued Jul. 18, 2006, the disclosure of which is incorporated herein by reference, links to different web pages provide prestige that can be quantified into a link structure database. A focused crawling alternative to the page rank citation-based technique allows yet another different type of search result.

From a review of much of the prior art references, each algorithm and method produces a different type of search result. Some search results are more focused on links, other search results are focused on keywords, and there are other types of search results such as those based on paid placement.

### SUMMARY OF THE INVENTION

This application borrows terminology from data mining, association rule learning and topology. Theoretically speaking, this invention uses a geometric structure to represent a collection of concepts in a document set. The geometric structure has a high-frequency keyword set that co-occurs closely which represents a concept in a document set. Document analysis seeks to automate the understanding of knowledge representing the author's idea. Granular computing theory deals with rough sets and fuzzy sets. One of the key insights of rough set research is that selection of different sets of features or variables will yield different concept granulations. Here, as in elementary rough set theory, by “concept” we mean a set of entities that are indistinguishable or indiscernible to the observer (i.e., a simple concept), or a set of entities that is composed from such simple concepts (i.e., a complex concept). Projecting a data set (value-attribute system) onto different sets of variables, produces alternative sets of equivalence-class “concepts” in the data (documents), and these different sets of concepts will in general be conducive to the extraction of different relationships and regularities (in documents).

The present invention applies theories of granular computing using the mathematical structure of a Simplicial Complex to represent the information flow (concept/idea/knowledge) in documents. The present invention seeks to maximize the capability of “reading between the lines” and capture previously hidden meanings in the documents. Therefore, the present invention focuses on trying to capture the concept or meaning of the text in the documents by clustering documents into groups based on similar and related words.

Theoretically speaking, the words in the documents can be modeled as an n-dimensional Euclidean space. An n-dimensional Euclidean space is a space in which elements can be addressed using the Cartesian product of n sets of real numbers. A unit point is a point whose coordinates are all 0 except for a single 1, (0, . . . , 0, 1, 0, . . . , 0). These unit points will be regarded as vertices. They will be used to illustrate the notion of n-simplex. Let us examine the n-simplices, when n=0, 1, 2, 3. A 0-simplex Δ(v₀) consists of a vertex v₀, which is a point in the Euclidean space. A 1-simplex Δ(v₀ v₁) consists of two points {v₀, v₁}. These two points can be interpreted as an open segment (v₀, v₁) in Euclidean space. Note that it does not include the end points. A 2-simplex Δ(v₀, v₁, v₂) consists of three points {v₀, v₁, v₂}. These three points can be interpreted as an open triangle with vertices v₀, v₁, and v₂, that does not include the edges and vertices. A 3-simplex Δ(v₀, v₁, v₂, v₃) consists of four points {v₀, v₁, v₂, v₃} and can be interpreted as an open tetrahedron. Again, it does not include any of its boundaries.

The following is an explanation of terminology in the data mining field. This invention uses TFIDF (Term Frequency Inverse Document Frequency) and SUPPORT as measures of the significance of tokens. A token is a categorized a block of text, which is typically a word for purposes of search engine usage. A word would be a number of letters. A string of input characters can be processed into word tokens by looking for spaces between groups of letters. For those of you who are reading this and are not computer scientists, it is easier to think of a token as another way of saying a word.

It follows that a token should be regarded as a keyword if and only if it has high TFIDF and SUPPORT values.

TFIDF Definition

Let Tr denote the total number of documents in the collection. We approximate the significance of a token ti in a document dj, itself in Tr, by its TFIDF value. It is calculated as

TFIDF(ti, dj)=tf(ti, dj)log(Tr/df(ti))

where df(ti) stands for Document Frequency and denotes the number of documents in Tr in which ti occurs at least once, and tf(ti, dj) stands for Term Frequency and is defined by

$$tf ( {t}_{i} , {d}_{j} ) = \{ \begin{matrix}1 + log ( N ( {t}_{i} , {d}_{j} ) ) & if N ( {t}_{i} , {d}_{j} ) > 0 \\ 0 & otherwise\end{matrix}$$

where ti is a term of document dj and N(ti, dj) denotes the frequency tᵢ in dⱼ.

Therefore, the TFIDF equals the Term Frequency multiplied by the log of the total number of documents divided by the document frequency. A log is short for ‘logarithm’ which is a function commonly found on scientific calculators. If one looks at a calculator that can perform scientific functions, there is typically a button marked ‘log’. Sometimes the button on the calculator is in uppercase, which would be ‘LOG’. To take a log of something, one can input the number and press the log button on the calculator.

The term frequency is equal to one plus the log of the frequency of a token in a document. The term frequency is a positive number or zero. It would not be a negative number. Term frequency could also be defined as the number of appearances of a term in a document divided by the total number of words in the document.

Typically, the TFIDF value is a measure to identify keywords, and the SUPPORT value is a measure of importance of the interesting keywordsets. Note that the TFIDF value only reflects the importance of a token in one particular document. In other words, its value is local to each (token, document) pair. It does not measure the overall significance of a token in the set of documents.

Also note that the idf(ti) value is at its highest when the token appears in only one document. The TFIDF value can be “tuned” by setting bounds on the idf( ) and tf( ) values as well as on the final TFIDF value. The notion of SUPPORT reflects the “frequency” of a keywordset within the set of documents.

Support Definition

The SUPPORT of a keyword or keywordset in a document set is the percentage of documents that contain the keyword or keywordset within a predefined number of tokens respectively. We say that the SUPPORT is high if it is greater than a given threshold value. Again, the TFIDF value is a measure to identify keywords, and the SUPPORT value the interesting keywordsets. SUPPORT for an association rule A=>B is the percentage of documents in the document set that contain keywordsets A U B greater or equal than the threshold value.

In traditional clustering, we partition a document set into disjoint groups, namely, equivalence classes of documents. However, many documents are inter-related in some concepts and totally unrelated in others. So we propose a concept based clustering where we use the conceptual structure of IDEA to group the concepts.

An n_{d}-keywordset is a set that has a high number of co-occurrences (SUPPORT) of n keywords that are at most d tokens apart. In the case that d and n are understood, and it is abbreviated simply as keywordset. High-frequency keywords within a set of documents carry certain concepts. Different concepts are represented by different keywordsets. These keywordsets occur frequently and can be extracted using Association Rule Mining techniques. Association Rule Mining is used to show the relationships between keywords. Interesting and important keywords occur frequently enough in a document set. Associations between these keywords create semantics beyond the meaning of the individual keywords.

The combinatorial structure has some linguistic meaning—The whole keyword simplicial complex represents the whole idea of a document set, a connected component represents a complete concept, called C-concept. These terms refer to some notion in a document set.

Keywordsets capture the “association semantics.” For example, the association “Wall street” is a financial concept, not the words “wall” and “street” individually. Based on these keywordsets, we build the simplicial complex. Each simplex represents a concept. This simplicial structure is a mathematical structure of concepts that are possibly hidden in the document set. Based on such a structure, we then cluster the documents.

Let us observe some interesting phenomena. A keywordset semantically may have nothing to do with its individual keywords. For example, the keywordset “Wall Street” represents a concept that has nothing to do with “Wall” and “Street”. The keywordset “White House” represents an object that has very little to do with “White” and “House.” Let A and B be two document sets, where B is a translation of A into another language then the simplicial complexes of A and the simplicial complexes of B are isomorphic. Using our model, we can determine if two sets of documents written in different languages are similar, even without translation.

### BRIEF DESCRIPTION OF THE DRAWINGS

FIG. 1 is a sample document.

FIG. 2 is a table showing keywords extracted from a sample document.

FIG. 3 is a frequency chart of tokens.

FIG. 4 is an example of a keyword set.

FIG. 5 is an example of two clusters of keywords.

FIG. 6 is a screenshot showing concepts found related with the word “chemistry”, with the first term having 618 documents selected.

FIG. 7 is a list of documents clustered by P-concept for the chemistry word search.

### DETAILED DISCUSSION OF THE PREFERRED EMBODIMENT

The following is a process of mining a data set to generate clusters of documents. The processes include the steps of tokenizing and stemming tokens from a data set, and calculating a TFIDF for each token to generate keywords. Additional steps include finding high-frequency co-occurring n-keywordsets by Association Rule Mining and mapping keywords association in simplicial complex structure. The procedure is carried out using a variety of relational database tables to store the data, and using SQL and Perl to manipulate the data.

A wide variety of online collection of documents are available. An example of a literature collection is one such as the collection of NSF Research Awards Abstracts which can be downloaded from the UC Irvine KDD Archive. Assuming using 19,876 out of 129,000 documents, the documents in this data set are limited to the titles and the abstracts for purposes of this example.

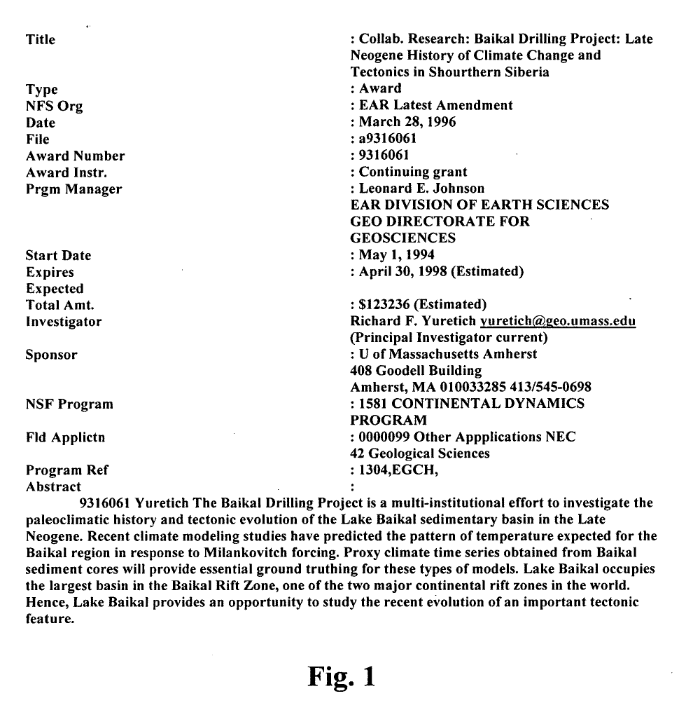

The data set is downloaded in text format. A text file is shown in FIG. 1. The text file has formatting which would include fields such as the title and abstract.

Pre-processing the data set includes the steps of tokenizing and stemming. The document set is tokenized into individual tokens in an array format:

<document id; token; position >

Document id is the document id of the document where the token occurs. Document id can be a file name. Token is the token or symbol which is used by the document author to express concepts, and position is the position of tokens within a document that can be stated as nth token in the document. Therefore, position is like the word number which is used as an address. Stemming is performed after all the documents have been tokenized into individual tokens.

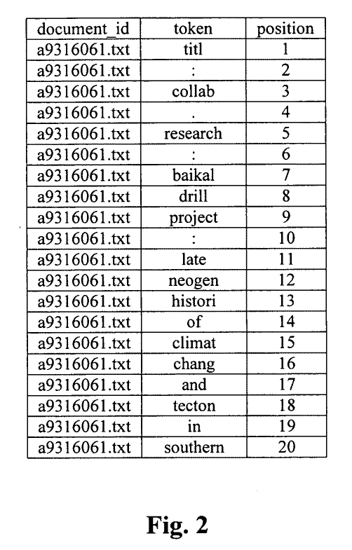

Stemming is needed to address the problem of Synonymy. Synonymy is the state where the common meaning of keywords might have different form of words originated from the same stem word. FIG. 2 shows data derived from the sample document that has been stemmed and tokenized.

Extracting Keywords

After creating the stemmed and tokenized data, the next step is to extract keywords based on TFIDF values. A TFIDF value is calculated or each token in a document collection. A token that appears in almost all documents in the collection will have a value close to zero. A token that appears only in one document will have the highest value. Therefore, not all of the words will be keywords.

A threshold for the TFDIF value is user predefined. For this particular example the sample uses 0.005 as the TFDIF predefined threshold value. TFDIF threshold could be set to 0.005 or somewhere in the range of 0.01 to 0.001. This value relates to an assumption that important keywords would not occur in more than 30% of the whole document and might occur twice in the average number of tokens in one document.

### Sample SQL Code to Calculate TFIDF

```
TOKENS = a relation of <docnum, term, position>
SELECT docnum, term,
((TFd/ totalTermInDoc) * log(10,(TDoc/DF)) ) tfidf
FROM
( SELECT count(distinct docnum) TDoc FROM TOKENS),
( SELECT docnum, term, TFd, DF
FROM (SELECT a.docnum, a.term, count(term) TFd
  FROM TOKENS a
  GROUP BY docnum, term)
  NATURAL JOIN
  (SELECT c.term, count(distinct docnum) DF
  FROM TOKENS c
  GROUP BY c.term))
NATURAL JOIN
(SELECT docnum, count(term) totalTermInDoc
FROM TOKENS b
GROUP BY docnum )
```

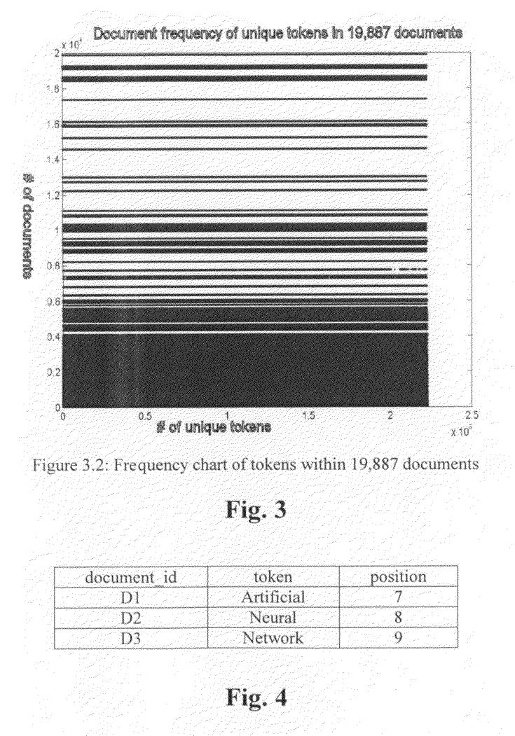

Words having a high-frequency of appearance in a set of documents (document frequency or DF) is also important. Therefore, a DF threshold is also predefined. In this example, the document frequency (DF) threshold is set to 100. FIG. 3 shows keywords that have been extracted by TFIDF values>0:005 and DF>100.

Keyword extraction is the process of finding frequently used words that have a consistent meaning across various documents. Words that are used often together may be treated as phrases such that they would have some associational meaning. Again, the TFIDF equals the Term Frequency multiplied by the log of the total number of documents divided by the document frequency. Words that have a sufficient TFDIF make the cut and become keywords. The keywords can be stored in a matrix database, an example of which is shown in FIG. 2.

Generating Keyword Sets

FIG. 4 is an example of a keyword set. The keyword set is derived from the keywords. In the example on FIG. 4, the keyword set is the term ‘artificial neural network’ which is a three word term. In this situation, the seventh word of document D1 is the word ‘artificial’. Neural is the eighth word of document D1 and network is the ninth word of document D1.

The keyword sets such as the one shown in FIG. 4 is derived from the keywords by using Association Rule Mining which tries to find the relations between co-occurring nearby keywords that might represent a different or new meaning, which would be more than the meaning of each keyword individually. For example, keyword \white” and \house” might point to a document about politics, yet its meaning has nothing to do the keywords \white” and \house”. Association Rule Mining has two measurements, SUPPORT and CONFIDENCE. Only the SUPPORT value indicating the minimum number of documents in which a keyword or keywordset must occur to be considered important is used.

The preferred Association rule mining algorithm has two steps, the first step is to filter out keywords and keyword sets that occur in high-frequency within a certain distance. The set distance is the within distance. The within distance threshold is user defined and can be changed.

The within distance corresponds to the distance between the words. For example, the within distance threshold can be an integer value with a best mode of 10. This would mean that the first word is no more than 10 words away from the last word of the keyword set. The within distance threshold would be the first filtering step. Even though the best mode for the English language is 10, the algorithm also works well if the within distance is from 8-12. Depending on different languages, different best modes will apply. Also, the within distance should be adjusted for the type of literature being searched, for example legal documents may require a larger within distance.

The second filtering step is to apply a SUPPORT value which can be expressed as the frequency of which the keyword set appears. The support value can be a percentage of the number of occurrences of the keyword set divided by the total number of documents. It is preferred to have a support value threshold user defined. This would be a separate filtering step.

CONFIDENCE equals the frequency of keyword appearance out of all keywordset appearance in all documents. This can be shown to the user when the user selects a keyword set that the user wants to review documents in. The confidence measurement is also a fraction or percentage and can be helpful for showing the user, or for internal use. CONFIDENCE for an association rule A→B is the ratio of the number of documents that contain keywordsets A U B to the number of documents that contains A. Simply, it is the ratio between SUPPORT(A U B) and SUPPORT(A).

Out of all of the potential keywords that occur close together, a chart showing keyword sets is generated using the filtering steps mentioned above. The Apriori Algorithm finds n-keywordset associations starting from n=1 which consists of one high-frequency keyword. The algorithm continues to generate n+1-keywordset which consists of n+1 high-frequency keywords that co-occur in no more than ten keywords of distance. The algorithm keeps generating n-keywordset until there is no n-keywordset that meets the minimum SUPPORT value that can be generated. Note that an n-keywordset is always generated from the n−1-keywordset.

The results show that documents are grouped by n-keywordset association which is believed to carry concepts inside documents. The meaning of geometric structures will explain document clustering based on the semantics of the structures.

This procedure can be expressed mathematically. Finding the n-keywordsets involves two steps. The first step is to generate the candidates that co-occur within a certain distance. This project uses ten as the max distance between keywords. This set of candidates is denoted as Cn. The second step is to find the frequent n-keywordsets from Cn which meet the minimum SUPPORT value. This subset of Cn is denoted as Ln. The process then generates the next candidate of n+1-keywordset (Cn+1) from Ln. In order to find Cn, a set of candidate n-itemsets is generated with a selfjoin on Lₙ₋₁. Let A and B be two instances of a relation of n−1-keywordsets. The relation is <document id; token, position>. The n-keywordset association from this Cartesian product must meet the following conditions:
1) (A.doc_id =B.doc_id) and
2) (A.pos₁<B.pos₁), for n=1. (A.pos₁=B.pos₁ ∩ A.pos2=B.pos2 ∩ . . . A.posₙ₋₁<B.posₙ₋₁), for n>1.
3) (A.pos₁+10≧B.posₙ₋₁)
4) (A.token₁≠B.token₁ ∩ A.token₂≠B.token₂ ∩ . . . ∩ A.tokenₙ≠B.tokenₙ)
   where posₙ is the position of token n and tokenₙ is nth token in doc_id.

The mathematical procedure discusses how a computer program would go through each and every possible combination of keyword sets to extract those that match the criteria predefined.

FIG. 4 is an example of a keyword set. This is one that was extracted and stored in a computer storage database.

One example can be used to illustrate the joining process. Suppose there are keywords “artificial neural network” in a document with keyword's positions 7, 8, 9 respectively as shown in Table 3.3. Assume the tuples have met the minimum SUPPORT value. Based on the previously stated condition which ensure that the joined keywords are not separated by more than ten keywords, 2-keywordset association in Table 3.4.1 is generated. 3-keywordset association in Table 3.5 is generated based on the same condition as well. The algorithm keeps finding n-keywords association based on the condition until there is no n-keywordset that meet the minimum SUPPORT value.

### Sample SQL Code to Generate N-Keywordsets

```
*Generating candidates of 2-keywordsets*
  SELECT a.docID, a.token token1 , b.token token2,
  a.position pos1, b.position pos2
  FROM 1KEYWORDSET a, 1KEYWORDSET b
  WHERE a.docID = b.docID
    and a.position < b.position
    and a.position + 10 > b.position
    and a.token <> b.token
*Generating frequent 2-keywordsets*
SELECT token1, token2, count(distinct docID) DF
FROM C2KEYWORDSETS
GROUP BY token1, token2
HAVING count(distinct docID) > 100
*Generating candidates of 3-keywordsets*
  SELECT a.docID, a.token1 , a.token2, b.token2,
    a.pos1, a.pos2, b.pos2
  FROM 2KEYWORDSET a, 2KEYWORDSET b
  WHERE a.docID = b.docID
    and a.pos1 = b.pos1
    and a.pos2 < b.pos2
    and a.token1 <> b.token2
    and a.token2 <> b.token2
*Generating frequent 3-keywordsets*
SELECT token1, token2, token3,
  count(distinct docID) DF
  FROM C3KEYWORDSETS
  GROUP BY token1, token2, token3
  HAVING count(distinct docID) > 100
*Generating candidates of 4-keywordsets*
  SELECT a.docID, a.token1, a.token2, a.token3, b.token3,
    a.pos1, a.pos2, a.pos3, b.pos3
  FROM 3KEYWORDSET a, 3KEYWORDSET b
  WHERE a.docID = b.docID
    and a.pos1 = b.pos1
    and a.pos2 = b.pos2
    and a.pos3 < b.pos3
    and a.token1 <> b.token3
    and a.token2 <> b.token3
    and a.token3 <> b.token3
  *Generating frequent 4-keywordsets*
  SELECT token1, token2, token3, token4
  count(distinct docID) DF
  FROM C4KEYWORDSETS
  GROUP BY token1, token2, token3, token4
  HAVING count(distinct docID) > 100
```

TABLE 3.4
2-keywordset Association

| A | | | B | | |
|---|---|---|---|---|---|
| D1 | artificial | 7 | D1 | neural | 8 |
| D1 | artificial | 7 | D1 | network | 9 |
| D1 | neural | 8 | D1 | network | 9 |

TABLE 3.5
3-keywordset Association

| | | | | | | |
|---|---|---|---|---|---|---|
| D1 | artificial | 7 | neural | 8 | network | 9 |

The algorithm can be formalized as follows:

```
Procedure find_keywordsets(C₁)
Let C₁ ← tuple of <docid, token, pos, TFIDF, SUPPORT>
L₁ ←{C₁ with high TFIDF}
k ←1
Do
  k ← k + 1
  Cₖ ← find_candidate(Lₖ−1)
  For each t ε Cₖ
    t.count ← t.count + 1
  Lₖ ← { t ε Cₖ − t.count >= SUPPORT}
while Lₖ ≠{Ø}
Return Lₖ
Procedure find_candidate( Lₖ₋₁)
For each A ε Lₖ₋₁
For each B ε Lₖ₋₁
If (A.docid = R.docid) and
  A.pos₁=B.pos₁∩ . . . ∩A.posₖ₋₂=B.posₖ₋₂ and
  A.tokenₖ₋₁ ≠B.Tokenₖ₋₁ and
  A.posₖ₋₁>B.posₖ₋₁ ∩ (A.posₖ₋₁ +distance) ≧B.posₖ₋₁
then
  ct←<docid,a.token1, a.token2, . . . a.tokenₖ₋₁, b.tokenₖ₋₁>
  Cₖ ← ∪{ ct}
Return Cₖ
```

The sample results show that documents are grouped by n-keywordset association which is hoped to approximate the concepts inside the documents. The meaning of geometric structures will be revisited to explain document clustering based on the semantics of the structures.

Note that the tables showing the results only show partial results since the whole result would be too large to be displayed on paper. Column A in the tables uniquely identifies the P-concept defined by the current tuple. Column B contains the relative cluster number to which this P-concept belongs. Column C states the number of documents in the data set that contain this P-cluster. The remaining numbered columns uniquely identify tokens. The high dimensional clusters are collected for clarity. Even though the result shows 7-keywordset as the maximum keywordset, it is easy to see now they can generalize n-keywordsets and build the mathematical structure. This allows one to more accurately capture the idea behind the set of documents.

Clustering by Concepts

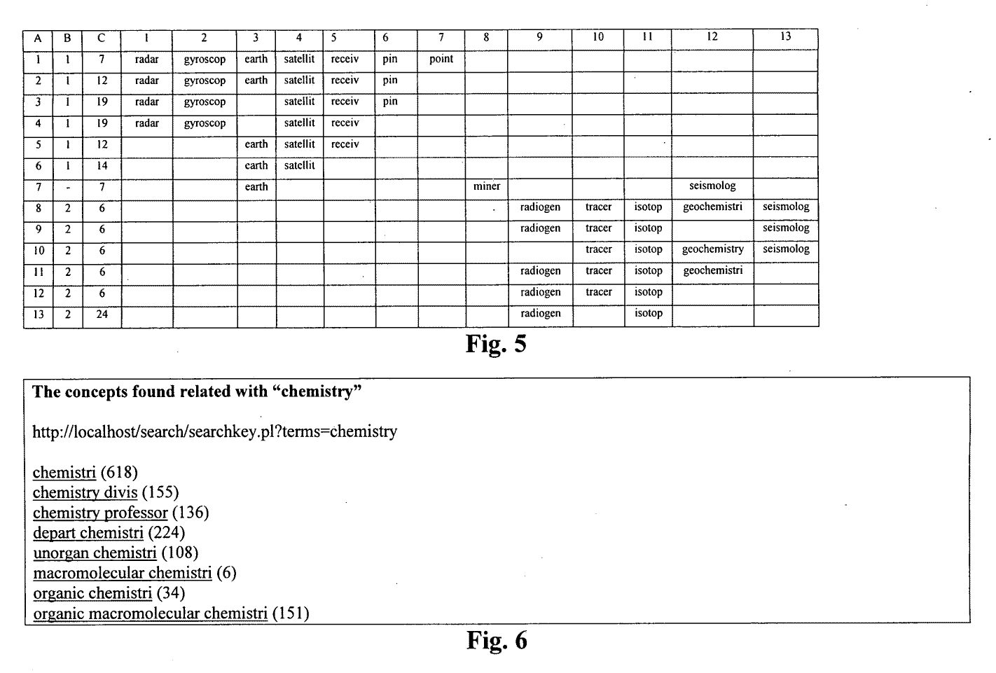

Taking a closer look at FIG. 5. It represents an interesting subcomplex of the KSC produced from the NSF document set. The topological term for keyword set is a simplicial complex or more specifically a Keyword Simplicial Complex (KSC).

Each tuple in FIG. 5 represents a cluster, called a P-cluster. P-concepts are used for clustering. Column A enumerates P-clusters. Column C indicates the number of documents in this P-cluster. The remaining columns list the keywords in this P-concept. FIG. 5 shows two C-concept clusters, the sub-complex that consists of the 2-simplex Δ(earth, miner, seismolog) representing a relative cluster. If dropped, one can make the two C-concept clusters disjoint.

In traditional clustering, a document set is partitioned into disjoint groups, namely, equivalence classes of documents. However, many documents are inter related in some concepts yet completely unrelated in others. A concept-based clustering where using the conceptual structure of IDEA to group the concepts is proposed.

The document index is built based on the n-keywordsets generated by Association Rule Mining process. The index is stored in a format of <simplex id; prefix id; key; dimension> where each tuple is an n-simplex with simplex id. The value of n is denoted by dimension field. The field key is the last vertex of the simplex with prefix id pointing to another simplex that contains its prefix. For example having the following simplex:
(organic, macromolecular, chemistri)
(organic, chemistri)
(chemistri)

These simplices can be represented as the following relation:

TABLE 4.1
Representation of Simplices in a Relation

| simplex_id | prefix_id | key | dimesion |
|---|---|---|---|
| 1 | 0 | organic | 1 |
| 2 | 0 | chemistri | 1 |
| 3 | 0 | macromolecular | 1 |
| 4 | 1 | chemistri | 2 |
| 5 | 1 | macromolecular | 2 |
| 6 | 5 | chemistri | 3 |

By representing simplices in such relation, space can be saved by \compressing” the length of n-simplex. A simplex that has prefix id=0 is 1-simplex, and a simplex id which is not referenced in the prefix id column is a maximal simplex. The index can be used to respond to the user's query and retrieve simplices which, in turn, retrieve documents grouped by the simplices.

FIG. 6 shows the screenshot of a demo program that retrieves the n-keywordsets in response to a query “chemistry.” The program returns the P-concept which contains \chemistry.” All the keywords shown in P-concept are in stemmed words. The numbers in parentheses are the number of documents containing the P-concept.

FIG. 5 is a small portion of a table that is a sample of database data that shows information regarding keywords. Column A is the P-cluster number. This number is simply a unique identifier. Column B is the relative cluster number to which the P-cluster belongs. Column C represents the number of documents that the P-cluster appears in.

FIG. 6 shows all the documents that are clustered under the concept of “chemistri.” The documents shown under the cluster of “chemistri” are documents that contains “chemistry”, but not the superset (“chemistri divis”, “chemistri professor”, etc). Likewise, the documents that are clustered by “chemistri divis” are documents that contain “chemistri divis” but not the subset (“chemistry” or “divis”). In other words, the documents shown are documents that contain maximal simplices. Each of the underlined text represents hyperlinks to the lists of documents having that keyword.

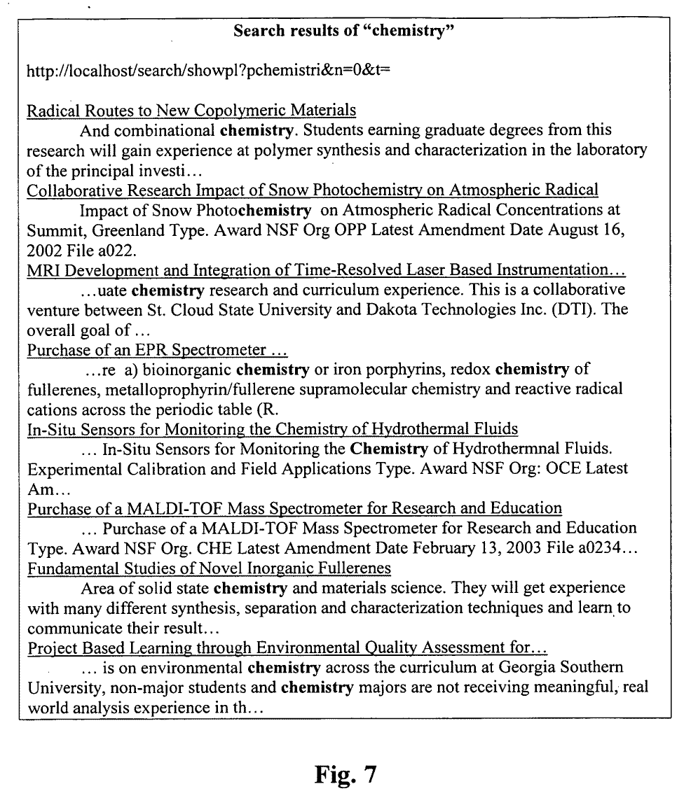

FIG. 7 shows a screenshot providing a list of all of the documents that are in the first cluster with hyperlinks to the documents themselves.

This invention can be combined with the techniques of other search engine strategies. For example, keyword sets can be listed alongside paid advertising links, or alongside any other type of search engine query result. Therefore, this present invention method need not be exclusively used as it can also supplement currently available and commonly used search engine algorithms and search engine query results.

A number of obvious modifications can be made to this application without departing from the spirit of the invention. For example, the array format or matrix format can be reformatted into a different format. The databases could be stored in a wide variety of different formats. Also, the language used to process the logical steps could be a variety of different computer languages. Therefore, while the presently preferred form of the system and method has been shown and described, and several modifications thereof discussed, persons skilled in this art will readily appreciate that various additional changes and modifications may be made without departing from the spirit of the invention, as defined and differentiated by the following claims.

1. A system of indexing documents comprising the steps of:
a. preprocessing documents to extract words;
b. then extracting keywords by calculating a TFIDF for each word, wherein the step of calculating a TFIDF further comprises the substeps of:
i. calculating a term frequency;
ii. calculating a document frequency;
iii. calculating a total number of documents in which a term appears at least once;
c. then comparing the TFIDF for each word with a TFIDF predefined threshold;
d. then finding keyword association by generating a plurality of keyword sets, wherein the step of generating a plurality of keyword sets further comprises the sub steps of:
i. filtering keyword sets that do not meet a predefined within distance threshold; and
ii. filtering keyword sets that do not meet a predefined support threshold, wherein the support threshold is compared to a support level which is proportional to the percentage of documents that contain the keyword set;
e. then providing a clustering of keyword sets and building a document index having a clustering of keyword sets;
f. then providing a search result in the form of a document cluster.

2. The system of claim 1, wherein the TFIDF for any particular term in a document equals the term frequency multiplied by the log of the total number of documents divided by the document frequency, wherein the term frequency is the number of appearances of a term in a document divided by the total number of words in the document.

3. The system of claim 1, wherein the TFIDF for any particular term in a document equals the term frequency multiplied by the log of the total number of documents divided by the document frequency, wherein term frequency is equal to one plus the log of the frequency of a token in a document.

4. The system of claim 1, further comprising the step of defining the predefined within distance having a value between 8 and 12.

5. The system of claim 1, further comprising the step of defining TFIDF predefined threshold having a range of 0.01 to 0.001.

6. A system of indexing documents comprising the steps of:
a. preprocessing documents to extract words;
b. then extracting keywords by calculating a TFIDF for each word,
c. then comparing the TFIDF for each word with a TFIDF predefined threshold;
d. then finding keyword association by generating a plurality of keyword sets,
e. then providing a clustering of keyword sets and building a document index having a clustering of keyword sets;
f. then allowing user selection of a query presented in the clustering of keyword sets;
g. then receiving a user selection of a query presented in the clustering of keyword sets;
h. then providing a search result in the form of a document cluster.

7. The system of indexing documents according to claim 6, wherein the step of calculating a TFIDF further comprises the substeps of: calculating a term frequency; calculating a document frequency; and calculating a total number of documents in which a term appears at least once.

8. The system of claim 7, wherein the TFIDF for any particular term in a document equals the term frequency multiplied by the log of the total number of documents divided by the document frequency, wherein the term frequency is the number of appearances of a term in a document divided by the total number of words in the document.

9. The system of claim 7, wherein the TFIDF for any particular term in a document equals the term frequency multiplied by the log of the total number of documents divided by the document frequency, wherein term frequency is equal to one plus the log of the frequency of a token in a document.

10. The system of claim 7, further comprising the step of defining the predefined within distance having a value between 8 and 12.

11. The system of claim 1, further comprising the step of defining TFIDF predefined threshold having a range of 0.01 to 0.001.

12. The system of indexing documents according to claim 6, wherein the step of generating a plurality of keyword sets further comprises the sub steps of: filtering keyword sets that do not meet a predefined within distance threshold; and filtering keyword sets that do not meet a predefined support threshold, wherein the support threshold is compared to a support level which is proportional to the percentage of documents that contain the keyword set.

13. The system of claim 12, wherein the TFIDF for any particular term in a document equals the term frequency multiplied by the log of the total number of documents divided by the document frequency, wherein the term frequency is the number of appearances of a term in a document divided by the total number of words in the document.

14. The system of claim 12, wherein the TFIDF for any particular term in a document equals the term frequency multiplied by the log of the total number of documents divided by the document frequency, wherein term frequency is equal to one plus the log of the frequency of a token in a document.

15. The system of claim 12, further comprising the step of defining the predefined within distance having a value between 8 and 12.

16. The system of claim 12, further comprising the step of defining TFIDF predefined threshold having a range of 0.01 to 0.001.

17. The system of indexing documents according to claim 6, wherein the step of generating a plurality of keyword sets further comprises the sub steps of: filtering keyword sets that do not meet a predefined within distance threshold; and filtering keyword sets that do not meet a predefined support threshold, wherein the support threshold is compared to a support level which is proportional to the percentage of documents that contain the keyword set, wherein the step of calculating a TFIDF further comprises the substeps of: calculating a term frequency; calculating a document frequency; and calculating a total number of documents in which a term appears at least once.

18. The system of claim 17, wherein the TFIDF for any particular term in a document equals the term frequency multiplied by the log of the total number of documents divided by the document frequency, wherein the term frequency is the number of appearances of a term in a document divided by the total number of words in the document.

19. The system of claim 18, wherein the TFIDF for any particular term in a document equals the term frequency multiplied by the log of the total number of documents divided by the document frequency, wherein term frequency is equal to one plus the log of the frequency of a token in a document.

20. The system of claim 18, further comprising the step of defining the predefined within distance having a value between 8 and 12.
